(19) United States
(12) Patent Application Publication
(10) Pub. No.: US 2009/0050754 A1
(43) Pub. Date: Feb. 26, 2009

(54) Cord caddy

(76) Inventors: William D. Thomas, Oakland, CA (US); Helen Hays-Thomas, Oakland, CA (US); Carmel M. Jackson, Calumet City, IL (US)

Correspondence Address: William D. Thomas, Apt 17A, 1200 Lakeshore Ave., Oakland, CA, 94606, US

(21) Appl. No.: 12/213,123

(22) Filed: Jun. 16, 2008

Related U.S. Application Data
(60) Provisional application No. 60/958,118, filed on Jul. 3, 2007.

(51) Int. Cl. F16L 3/00

(52) U.S. Cl. 248/51

(57) ABSTRACT

The Cord Caddy is an invention that provides a safe convenient way to store an irons' cord when the iron is not in use. The Cord Caddy is also a revolutionary way to remove cord clutter of any kind because it can be made to accommodate almost any type or size cord.

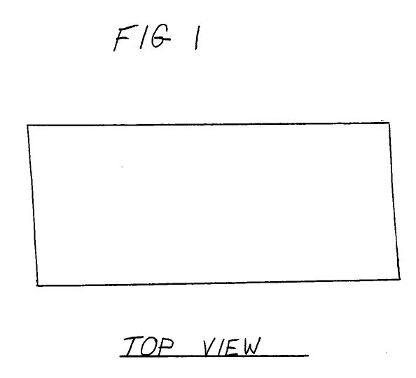

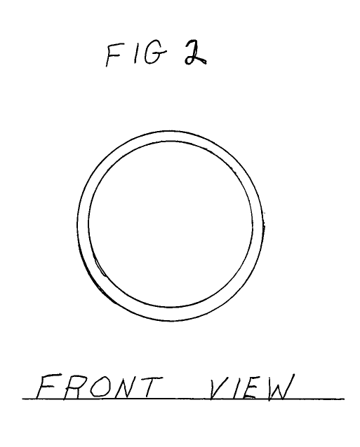

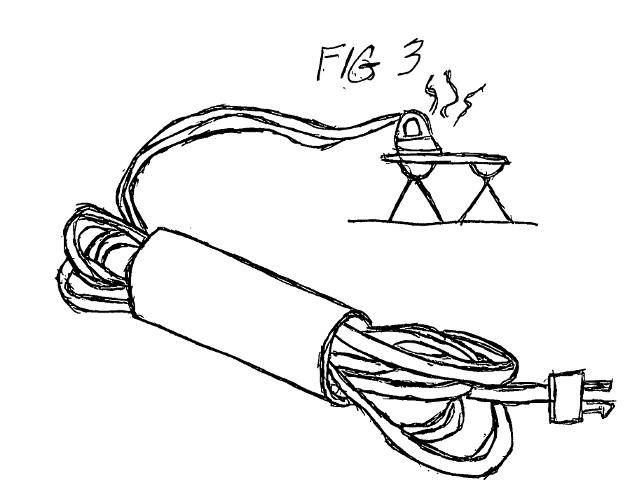

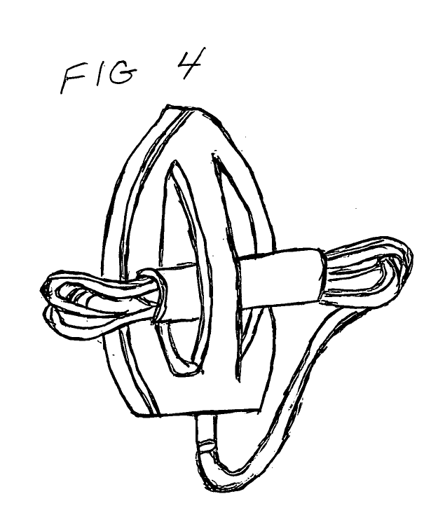

### PURPOSE OF THE INVENTION

We claim priority to Provisional Patent Application No. 60958118 filed on Jul. 3, 2007.

The cord caddy is a uniquely designed cord storage device that will hold the cord securely while the iron is stowed. The cord caddy was created to provide a safe, convenient way to store an iron's cord when the iron is not in use. This convenient and easy to use product will keep an iron's cord out of the reach of children and pets preventing damage to the cord and the iron. The innovative design of the cord caddy will provide an efficient and safe way to stow an iron until needed for use.

### PROBLEMS THE INVENTION SOLVES

The dangling cord of an iron can be a temptation to young children and pets. A hot iron is often left on the ironing board to cool and the cord is likely seen hanging off the board. This can be dangerous and inconvenient as even the most conscientious consumer could easily fall over the cord, pulling it off the board and onto the floor, damaging the iron and items with which the hot iron comes in contact. Storing a cooled iron can also provide difficult, as the long cord cannot be wrapped easily around the iron. Without a box, keeping the iron and cord safely and conveniently stored can be a nuisance. The cord caddy offers a simple and inexpensive way to store an iron's cord.

### DETAILED DESCRIPTION OF THE INVENTION

The cord caddy was created to provide a safe and convenient way to store an iron's cord neatly out of the way. This product comprises a flexible, hollow cylinder measuring approximately 1¾′ diameter and 4½″ long. Open at both ends, the cord caddy will allow for a user to insert the folded cord into the unit through either end with enough space to accommodate the cord. The cord caddy is then tucked away under the arm/handle of the iron. The durable material product could be made in various colors and may note a logo on the outside. The cord caddy will hold the cord inside until the iron is readied for use. Additional design variations may enable the cord caddy to house cords from other electrical equipment such as power tools, crafting tools and extension cords.

1. What we claim as our invention the Cord Caddy is a uniquely designed cord storage device that can be modified to securely hold almost any size cord.
